(19) United States
(12) Patent Application Publication
(10) Pub. No.: US 2015/0310498 A1
(43) Pub. Date: Oct. 29, 2015

(54) Computer-Implemented Systems and Methods for Generating Media Content Recommendations for Subsequent Works

(71) Applicant: Jeffrey D. Brandstetter, San Francisco, CA (US)

(72) Inventor: Jeffrey D. Brandstetter, San Francisco, CA (US)

(21) Appl. No.: 14/694,414

(22) Filed: Apr. 23, 2015

Related U.S. Application Data
(60) Provisional application No. 61/985,767, filed on Apr. 29, 2014.

(51) Int. Cl. G06Q 30/02

(52) U.S. Cl. CPC G06Q 30/0269

(57) ABSTRACT

Systems and methods are provided for continuing engagement of or growing an audience for a first item of media content and evaluating a recommendation for generation of a second item of media content after release of the first item of media content. An activity level associated with a first item of media content is tracked. An interstitial content item associated with the first item of media content is provided, and an activity level associated with the interstitial content item is tracked. The activity level associated with the first item of media content and the activity level associated with the interstitial content item are evaluated using a computer-implemented scoring model to generate a recommendation score. A recommendation is generated as to whether the second item of media content should be generated based on the recommendation score, where the recommendation is stored in a computer-readable medium.

### CROSS REFERENCE TO RELATED APPLICATIONS

This application claims priority to U.S. Provisional Patent Application No. 61/985,767 entitled “Systems and Methods for Generating Media Content Recommendations Regarding Subsequent Works,” filed Apr. 29, 2014, the entirety of which is herein incorporated by reference.

### TECHNICAL FIELD

This document relates generally to content management and more specifically to analytical evaluation of interstitial content to determine whether later content should be generated.

### BACKGROUND

The period of time it takes to produce and release (e.g., distribute) a film, television program or online video game can be lengthy. As a result, considerable time may pass between the production and release of the first content (e.g., film, television program, or online video game) in a series or franchise (franchise) and subsequent content in the franchise. This sometimes results in waning interest by the target demographic in the franchise until marketing commences for the subsequent content in the franchise. In addition, the economic viability of later content (e.g., a sequel, prequel, ancillary or other content) related to the first content is often highly speculative. There are, at present, relatively few meaningful metrics with which to gauge audience interest in further installments in a franchise. While there have been attempts to track the economic viability of related content following the release of original works (e.g., analyses comparing the success of a sequel or prequel relative to that of the original, first content alone), there is no current system or method that provides a predictive function based on actual viewership of subsequently released works (e.g., interstitial content analyzed for the purpose of determining the economic viability of producing and releasing a second content item related to the first content item).

### SUMMARY

In accordance with the teachings herein, systems and methods are provided for continuing engagement of or growing an audience for a first item of media content and evaluating a recommendation for generation of a second item of media content after release of the first item of media content. An activity level associated with a first item of media content is tracked. An interstitial content item associated with the first item of media content is provided, and an activity level associated with the interstitial content item is tracked. The activity level associated with the first item of media content and the activity level associated with the interstitial content item are evaluated using a computer-implemented scoring model to generate a recommendation score. A recommendation is generated as to whether the second item of media content should be generated based on the recommendation score, where the recommendation is stored in a computer-readable medium.

As another example, a system for continuing engagement of or growing an audience for a first item of media content and evaluating a recommendation for generation of a second item of media content after release of the first item of media content includes a computing platform configured to market or provide access to an interstitial content item related to the first item of media content. One or more computer-readable mediums are configured for storage of a first item data record, where the first item data record identifies the first item of media content and an activity level associated with the first item of media content, and an interstitial content data record, where the interstitial content data record identifies the first item of media content, the interstitial content item, and an activity level associated with the interstitial content item. The system further includes one or more data processors configured to generate a recommendation as to whether the second item of media content should be generated based on the first item data record and the interstitial content data record, where the recommendation is stored in a computer-readable medium.

As a further example, a computer-readable medium is encoded with instructions for commanding one or more data processors to execute a method for continuing engagement of or growing an audience for a first item of media content and evaluating a recommendation for generation of a second item of media content after release of the first item of media content. In the method, an activity level associated with a first item of media content is tracked. An interstitial content item associated with the first item of media content is provided, and an activity level associated with the interstitial content item is tracked. The activity level associated with the first item of media content and the activity level associated with the interstitial content item are evaluated using a computer-implemented scoring model to generate a recommendation score. A recommendation is generated as to whether the second item of media content should be generated based on the recommendation score, where the recommendation is stored in a computer-readable medium.

### BRIEF DESCRIPTION OF THE FIGURES

FIG. 1 is a block diagram depicting a processor-implemented system for providing a recommendation as to whether a second item of media content should be generated based on a success of a first item of media content and a follow-on interstitial content item.

FIG. 2 is a block diagram depicting example details of a processor-implemented recommendation engine generating a second content item recommendation.

FIG. 3 is a block diagram depicting a processor-implemented recommendation engine that provides a plot line recommendation for a downstream content item based on a popularity of one or more interstitial content items.

FIGS. 4A, 4B, and 4C depict example systems for implementing the approaches described herein for providing downstream content generation recommendations based on interstitial content item activity levels.

### DETAILED DESCRIPTION

Embodiments of the present invention provide systems and methods for determining the economic viability of, cross-promoting, and increasing revenues derived from, sequels, prequels, ancillary or other related media content, by generating, measuring and reporting metrics for online audiences/viewers of such content. The availability of such metrics can provide the economic justification for the creation of rich media content (i.e., a film, television program or video game, or series of films, television programs or video games) written, produced and released in such a way that the end of one media type's storyline is the start of/jumping off point for a different media type's storyline. For example, the end of a film's storyline may be the beginning of a video game storyline (or a jumping off point for multiple video games, each with its own unique, possibly divergent, storyline), and vice versa (that is, the end of each video game may be a unique potential starting point for a sequel or prequel film in a film series or franchise). The online distribution of such rich media content enables content providers and others to measure, maintain, and grow the audience of a film, television or video game franchise through the use of interstitial content of a different media type (e.g., online video game content released in between the release of films in a film franchise). As used throughout this disclosure, “interstitial” means content that is released/aired in between related content in a different medium; it does not refer to the length or run time of any such interstitial/“in between” content, and is not in any way limited to short content or programming in between longer content segments.

Another way of describing these systems and methods is that it provides a means of generating, measuring, and reporting metrics related to the transmedia exploitation of rich media (e.g., film, television or video game content). The availability of such metrics can: (1) assist content creators and others in determining the economic viability of creating and exploiting rich media that is traditionally exploited in only one or two formats (e.g., film and TV) across multiple media types (e.g., film, TV and video games); (2) justify and encourage transformation of such rich media into a transmedia story/experience told in part via film and/or TV, and in part via video game(s), and vice versa (i.e., from video games to film/TV), or in some combination of all three media types (e.g., an initial film, followed by related a video game(s), followed by a television series or MOW), which, in turn, both cross-promotes each media type and increases the revenues derived therefrom. This transmedia approach to content creation and exploitation fundamentally changes the way that content is traditionally created initially (i.e., at its inception) in terms of storylines, plot lines, character arcs, and other story elements—i.e., from works created for primary exploitation in one or two media types (film/TV or video game) to works created as transmedia content from their inception. Creating and releasing such content allows viewers/users to follow characters, storylines, plot lines and the like outside of a show or video game's initial plot while waiting for the next installment/episode to be produced and released.

Providing systems and methods for measuring and reporting metrics pertaining to the online distribution of a film, television or video game sequel, prequel, ancillary or other media content related to previously-released film, television or video game content, enables content providers, studios, networks, distributors and others to:

1. Assess the economic viability of a film, television or video game sequel, prequel, ancillary or other related media content by generating metrics, based on the interest in, amount of interaction with, or install base for, each interstitial media content item. Such interstitial content items can be used to validate or as evidence of the size of the core audience for the next media type in the series. For example, if a film is produced and released initially, and thereafter a related video game is released with a storyline that picks up where the initial film left off, the popularity and success of that video game is an important indicator of the economic viability of a subsequent film in the franchise. Moreover, the release of film, television or video game sequel, prequel, ancillary or other related media content can also provide additional vehicles for spin-off storylines or interstitial video content to fill production gaps between each film, television program or video game, and provide the ability to measure and report viewer/user and other metrics pertaining to that related media can further help assess the economic viability of a franchise or any of its constituent elements. If, for example, multiple related video game titles are produced/released after the initial film, each with a different storyline picking up from where the film left off (a la a multiverse/multiple universe approach to the storylines), the popularity of a particular storyline would be an indicator of which storyline has the greatest economic potential to pursue in a film sequel or prequel.

2. Increase the economic viability of a franchise by maintaining, or even growing, audience interest in the franchise in between releases (e.g., audience interest in a franchise can be maintained or increased after the release of a first film), but prior to the release of a subsequent film in the franchise, through ongoing video game engagement with video games that are related to the franchise and that pursue one or more storylines set up by the first film. Such interstitial video games thereby growing the install base audience for the franchise.

3. Generate ancillary film, television, or video game revenues through the sale or rental of interstitial content (e.g., in the example described in (2) above, the sale or rental of both the video game released after the initial film and any subsequent film(s) constitute additional income/revenues flowing from that initial film).

4. Cross-market/cross-promote related media content across each media type (e.g., a film can cross promote a related television program, which, in turn, can cross promote related video games, which, in turn, can cross promote both the related film and television series/franchise, ad infinitum).

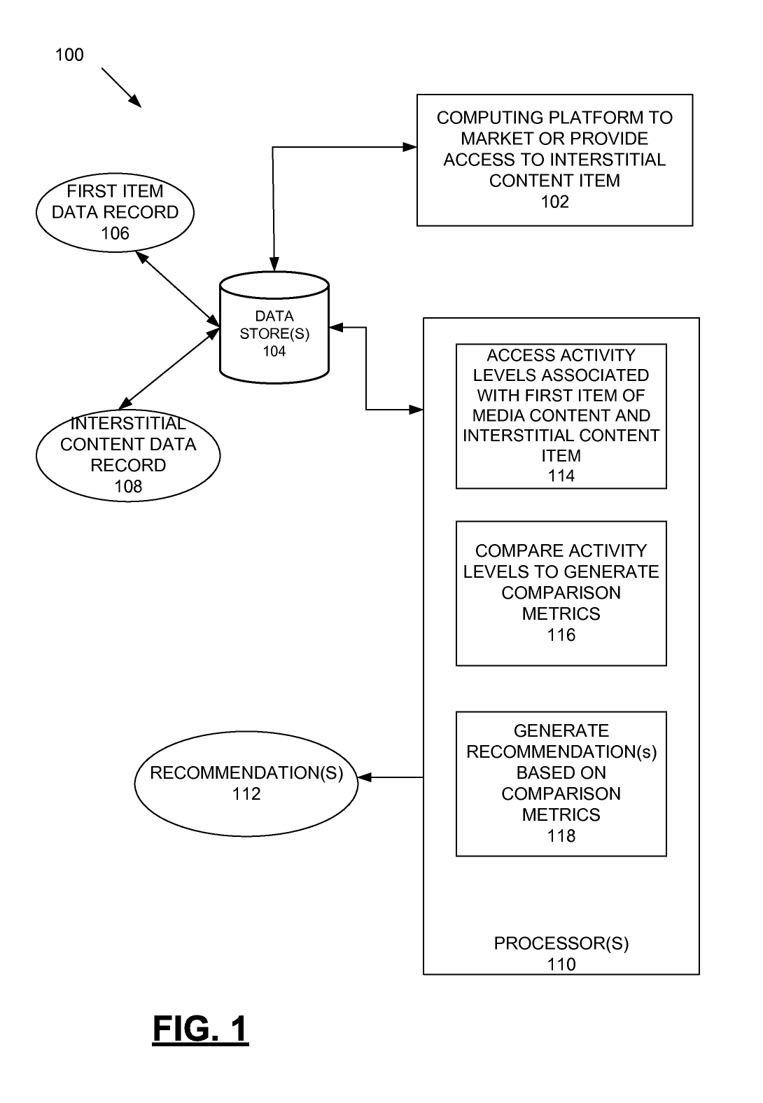

FIG. 1 is a block diagram depicting a processor-implemented system for providing a recommendation as to whether a second item of media content should be generated based on a success of a first item of media content and a follow-on interstitial content item. A system 100 includes a computing platform 102 is configured to market or provide access to an interstitial content item (e.g., a video game, a movie, a television program, a video, a video short, user-generated content, a mashup, a book, or a comic book) related to a first item of media content. In one example, the first content item is a movie, and the interstitial content item is a video game that is associated with the storyline of the first content item (e.g., the video game storyline continues at the end of the movie). The computing platform 102 makes the interstitial content item available and/or tracks popularity data associated with the interstitial content item. For example, the computing platform 102 could make an interstitial video game content item available for download (e.g., via an app store, a gaming (PlayStation) network) and then track certain metrics associated with that interstitial video game, such as number of downloads, or engagement metrics such as number of times played, amount of times played, and number of times played until completion. In another example, interstitial content is presented in the form of a number of short videos that continue the storyline of the first content item. Popularity metrics can then be extracted for each storyline via metrics such as number of downloads, number of views to completion, and number of likes.

Such metrics are provided to a computer-readable medium 104 for storage. In one embodiment, a data store 104 includes a data record 106 associated with the first content item (e.g., the initial movie). The first item data record 106 identifies the first item of media content and an activity level associated with that first item of media content, such as viewers, revenues, or some other measure of popularity. An interstitial content data record 108 stores data associated with an interstitial content item. In one example, such a data record 108 identifies the first item of media content with which the interstitial content item is related, identifies the interstitial content item, and stores data associated with an activity level (e.g., downloads, views, likes, engagement time) for the interstitial content item.

One or more data processors 110 are configured to operate on data from the data records 106, 108 to provide an automated recommendation 112 for whether a downstream second content item (e.g., a sequel movie) should be generated based on the observed popularity of the first item of media content and the interstitial content item. In one embodiment, where popularity of multiple interstitial content items is observed, the recommendation engine 110 can also indicate a suggested storyline (e.g., based on a storyline of a most popular of the interstitial content items) for the second content item. At 114, the recommendation engine accesses activity levels associated with the first item of media content and the interstitial content item, such as from the one or more data stores 104. In an embodiment having multiple interstitial content items, activity metrics associated with those interstitial content items are compared at 116, such as to identify which are most popular. At 118, the recommendation engine analyzes the input data, such as using a computer-implemented automated scoring model that provides artificial intelligence, to output a recommendation as to whether a second item of media content should be generated at all, and in some embodiments a storyline for that second item of media content that is most likely to yield the most success.

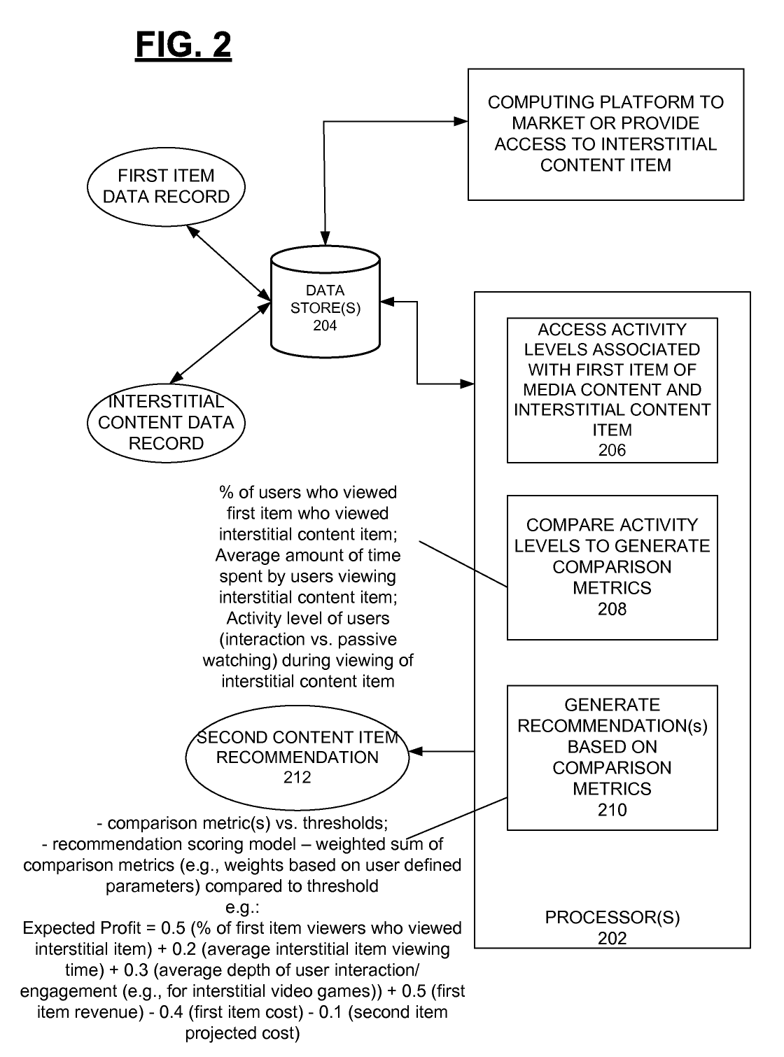

FIG. 2 is a block diagram depicting example details of a processor-implemented recommendation engine generating a second content item recommendation. The content recommendation engine 202 accesses interaction data associated with a first item of media content and one or more interstitial content items, such as from data records stored in a data store 204 at 206. At 208, one or more activity levels are compared to generate comparison metrics. Such comparison metrics could include a percentage of users who viewed the first content item who also viewed a particular interstitial content item. Another comparison metric measures an average amount of time spent by users viewing the particular interstitial content item. For interactive interstitial content items (e.g., branching video content items, video games), a comparison metric measures activity levels of interstitial content item users (e.g., interactive versus passive watching) during viewing of the particular interstitial content item.

The comparison metrics derived at 208 along with activity levels accessed from the data stores 204 are input to a processor-implemented scoring model at 210 to automatically generate a second content item recommendation 212. In one example, the scoring model 210 is generated by performing a linear regression analysis to identify parameters for inclusion in the model 210 and associated weights for those parameters. In one example, parameter data associated with a large number of historic first content item movies and follow-on interstitial content is compiled along with profits realized for second content item sequel movies. A linear regression is performed using the parameter data associated with the first content item movies, the follow-on interstitial content, and the second content item sequel movies to generate a weighted sum, whose result is predictive of the expected profit for a second content item sequel movie. In one example, the weighted sum utilized by the trained scoring model 210 is represented as:

Expected Profit=0.5 (% of first item viewers who viewed interstitial item)+0.2 (average interstitial item viewing time)+0.3 (average depth of user interaction/engagement (e.g., for interstitial video games))+0.5 (first item revenue)−0.4 (first item cost)−0.1 (second item projected cost).

Based on an expected profit level predicted by the model 210, a recommendation 212 as to whether the second content item should be generated is generated and output. In one example, a single threshold is utilized in making the recommendation, such as a threshold that recommends making the second content item when the expected profit is greater than zero or greater than a certain desired return on investment. In another example, the recommendation is made based on a series of ranges (e.g., Expected profit: −$20M or worse: avoid; Expected profit: −$20M to −5M: underperform; Expected profit: $−5M to 5M: neutral; Expected profit: $5M to 20M: recommend; Expected profit: $20M or better: strongly recommend). In another example, a stoplight is provided on a graphical user interface (green—recommend; yellow—neutral; red—avoid) based on a comparison of the expected profit with a series of thresholds. In another example, a color chart is provided on a graphical user interface that displays colors (e.g., green—strongly recommend; blue—recommend; yellow—neutral; orange—underperform; red—avoid) based on a comparison of the expected profit with a series of thresholds.

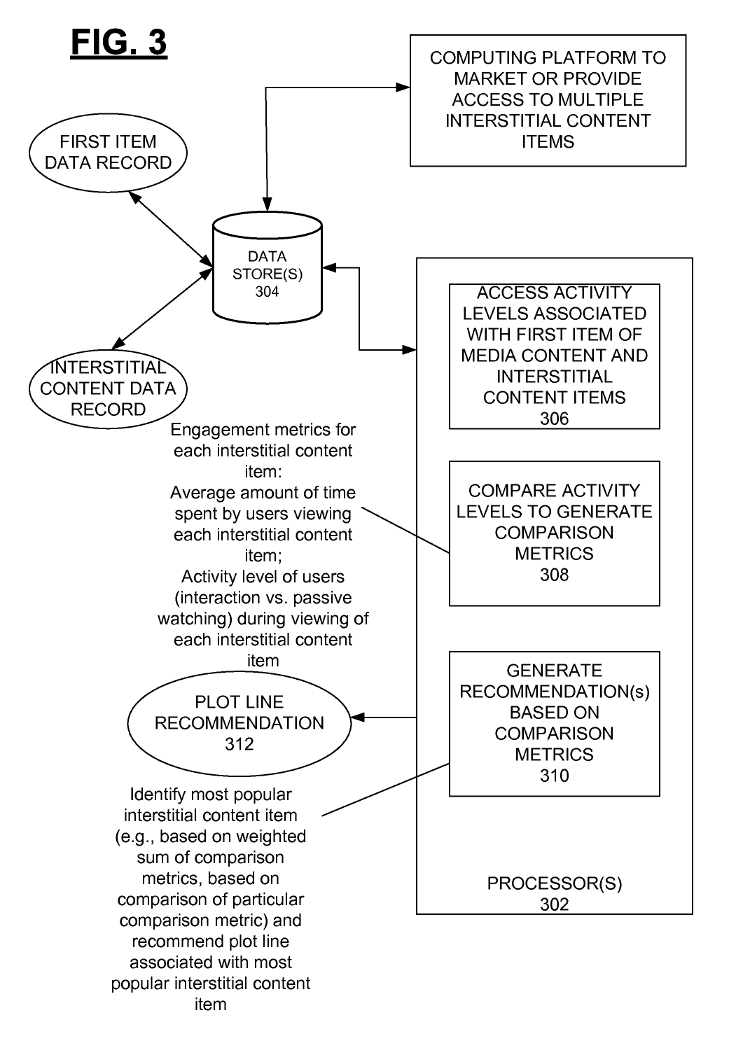

FIG. 3 is a block diagram depicting a processor-implemented recommendation engine that provides a plot line recommendation for a downstream content item based on a popularity of one or more interstitial content items. The content recommendation engine 302 accesses interaction data associated with a first item of media content and one or more interstitial content items, such as from data records stored in a data store 304 at 306. At 308, one or more activity levels are compared to generate comparison metrics for each of a plurality of interstitial content items. In one embodiment, engagement metrics for each interstitial content item include an average amount of time spent by viewers viewing each interstitial content item and an activity level of users during viewing of each interstitial content item. Such comparison metrics from 308 along with any other activity metrics from the data store for the first content item and the interstitial content item are provided to a scoring model at 310 to provide a recommendation as to whether any downstream second content item should be generated at all, and if so, what plot line should be pursued in that second content item. In one embodiment, the model at 310 identifies which of the interstitial content items is most popular (e.g., based on a weighted sum of comparison metrics generated at 308 or a direct comparison of a particular comparison metric across the multiple interstitial content items). The scoring model then outputs a recommendation at 312 that includes a suggestion for a plot line for the second item of media content based on the observed interactions with the interstitial content items.

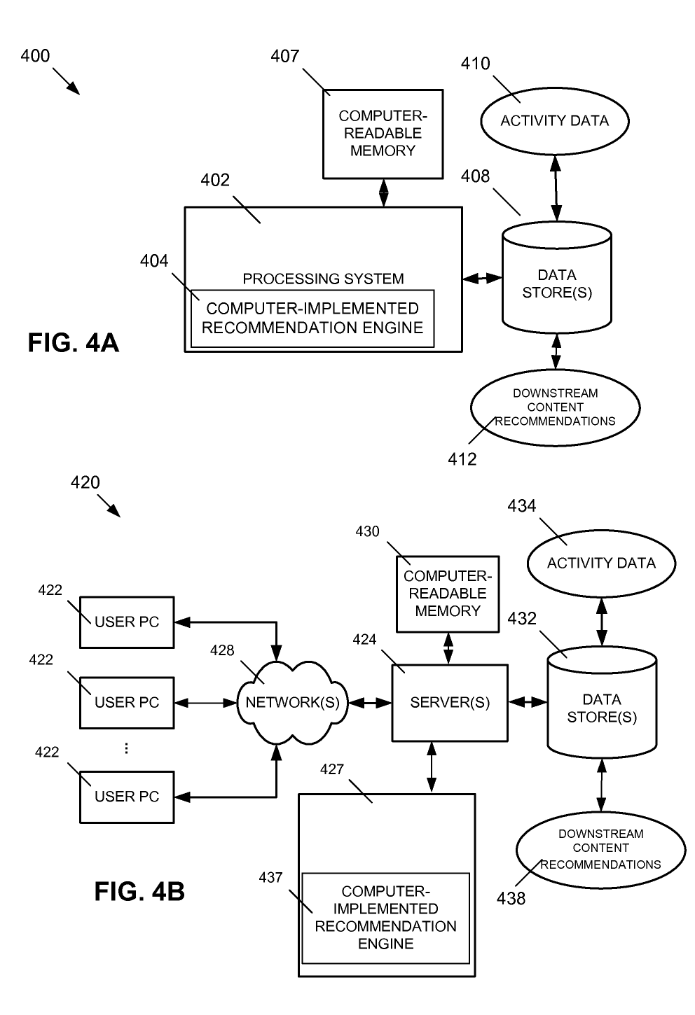

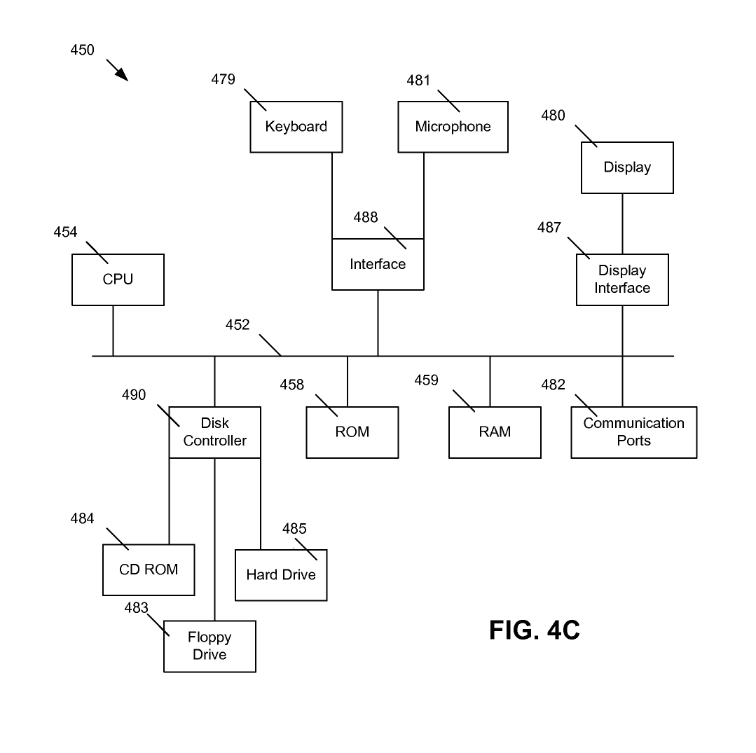

FIGS. 4A, 4B, and 4C depict example systems for implementing the approaches described herein for providing downstream content generation recommendations based on interstitial content item activity levels. For example, FIG. 4A depicts an exemplary system 400 that includes a standalone computer architecture where a processing system 402 (e.g., one or more computer processors located in a given computer or in multiple computers that may be separate and distinct from one another) includes a recommendation engine 404 being executed on the processing system 402. The processing system 402 has access to a computer-readable memory 407 in addition to one or more data stores 408. The one or more data stores 408 may include content activity data 410 as well as downstream content recommendations 412. The processing system 402 may be a distributed parallel computing environment, which may be used to handle very large-scale data sets.

FIG. 4B depicts a system 420 that includes a client-server architecture. One or more user PCs 422 access one or more servers 424 running a recommendation engine 437 on a processing system 427 via one or more networks 428. The one or more servers 424 may access a computer-readable memory 430 as well as one or more data stores 432. The one or more data stores 432 may include content activity data 434 as well as downstream content recommendations 438.

FIG. 4C shows a block diagram of exemplary hardware for a standalone computer architecture 450, such as the architecture depicted in FIG. 4A that may be used to include and/or implement the program instructions of system embodiments of the present disclosure. A bus 452 may serve as the information highway interconnecting the other illustrated components of the hardware. A processing system 454 labeled CPU (central processing unit) (e.g., one or more computer processors at a given computer or at multiple computers), may perform calculations and logic operations required to execute a program. A non-transitory processor-readable storage medium, such as read only memory (ROM) 458 and random access memory (RAM) 459, may be in communication with the processing system 454 and may include one or more programming instructions for performing the method of providing downstream content generation recommendations based on interstitial content item activity levels. Optionally, program instructions may be stored on a non-transitory computer-readable storage medium such as a magnetic disk, optical disk, recordable memory device, flash memory, or other physical storage medium.

In FIGS. 4A, 4B, and 4C, computer readable memories 408, 430, 458, 459 or data stores 408, 432, 483, 484, 488 may include one or more data structures for storing and associating various data used in the example systems for providing content generation recommendations to a user. For example, a data structure stored in any of the aforementioned locations may be used to store data from XML files, initial parameters, and/or data for other variables described herein. A disk controller 490 interfaces one or more optional disk drives to the system bus 452. These disk drives may be external or internal floppy disk drives such as 483, external or internal CD-ROM, CD-R, CD-RW or DVD drives such as 484, or external or internal hard drives 485. As indicated previously, these various disk drives and disk controllers are optional devices.

Each of the element managers, real-time data buffer, conveyors, file input processor, database index shared access memory loader, reference data buffer and data managers may include a software application stored in one or more of the disk drives connected to the disk controller 490, the ROM 458 and/or the RAM 459. The processor 454 may access one or more components as required.

A display interface 487 may permit information from the bus 452 to be displayed on a display 480 in audio, graphic, or alphanumeric format. Communication with external devices may optionally occur using various communication ports 482.

In addition to these computer-type components, the hardware may also include data input devices, such as a keyboard 479, or other input device 481, such as a microphone, remote control, pointer, mouse and/or joystick.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein and may be provided in any suitable language such as C, C++, JAVA, for example, or any other suitable programming language. Other implementations may also be used, however, such as firmware or even appropriately designed hardware configured to carry out the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

While the disclosure has been described in detail and with reference to specific embodiments thereof, it will be apparent to one skilled in the art that various changes and modifications can be made therein without departing from the spirit and scope of the embodiments. For example, while the systems and methods as described herein are described with reference to audio, text, image, and video content, the systems and methods can be expanded to provide content based on user preferences for other content such as dating (spectrums based on height, race, religion, interests) or pornography. Thus, it is intended that the present disclosure cover the modifications and variations of this disclosure provided they come within the scope of the appended claims and their equivalents.

It is claimed:

1. A system for continuing engagement of or growing an audience for a first item of media content and evaluating a recommendation for generation of a second item of media content after release of the first item of media content, comprising:
a computing platform configured to market or provide access to an interstitial content item related to the first item of media content;
one or more computer-readable mediums configured for storage of:
a first item data record, wherein the first item data record identifies the first item of media content and an activity level associated with the first item of media content;
an interstitial content data record, wherein the interstitial content data record identifies the first item of media content, the interstitial content item, and an activity level associated with the interstitial content item;
one or more data processors configured to:
generate a recommendation as to whether the second item of media content should be generated based on the first item data record and the interstitial content data record, wherein the recommendation is stored in a computer-readable medium.

2. The system of claim 1, wherein the interstitial content item comprises media content of any length and any media type that is made available after the first item of media content is made available and before the second item of media content is made available.

3. The system of claim 1, wherein generating a recommendation as to whether the second item of media content should be generated comprises:
generating a plurality of comparison metrics based on the activity level associated with the first item of media content and the activity level associated with the interstitial content item, wherein the comparison metrics include a metric based on a percentage of users who viewed the first item who also viewed the interstitial content item;
providing the plurality of comparison metrics to a scoring model, wherein the scoring model generates a weighted sum of the comparison metrics;
comparing the weighted sum of the comparison metrics to a threshold;
recommending that the second item of media content should be generated when the weighted sum meets a second item of media content threshold.

4. The system of claim 1, wherein the recommendation further provides a content recommendation for the second item of media content, wherein the content recommendation indicates a recommended plot line for the second item of media content.

5. The system of claim 4, wherein the one or more computer-readable mediums is further configured for storage of:
a second interstitial content data record, wherein the interstitial content data record identifies the first item of media content, a second interstitial content item, and an activity level associated with the second interstitial content item;
wherein the interstitial content item is associated with a first plot line, and wherein the second interstitial content item is associated with a second plot line;
wherein the content recommendation identifies the first plot line or the second plot line based on the activity level associated with the interstitial content item and the activity level associated with the second interstitial content item.

6. The system of claim 5, wherein generating the recommended plot line comprises:
generating a plurality of comparison metrics based on the activity level associated with the interstitial content item and the activity level associated with the second interstitial content item, wherein the comparison metrics include a metric based on an average amount of time spent by users viewing the interstitial content item and a second metric based on an average amount of time spent by users viewing the second interstitial content item;
providing the plurality of comparison metrics to a scoring model, wherein the scoring model generates a weighted sum of the comparison metrics;
determining which of the interstitial content item and the second interstitial content item is more popular;
recommending a plot line associated with the more popular of the interstitial content item and the second interstitial content item for inclusion in the second item of media content.

7. The system of claim 5, wherein the activity level associated with the interstitial content item indicates an average user interaction time with the interstitial content item;
wherein the activity level associated with the second interstitial content item indicates an average user interaction time with the second interstitial content item; and
wherein the content recommendation is based on a comparison of the average user interaction time with the interstitial content item and the average user interaction time with the second interstitial content item.

8. The system of claim 1, wherein the recommendation is based on a comparison of the activity level associated with the first item of media content and the activity level associated with the interstitial content item.

9. The system of claim 7, wherein the comparison identifies a proportion of users who viewed the first item of media content who accessed the interstitial content item.

10. The system of claim 1, wherein the recommendation is generated based one or more user defined recommendation preferences.

11. The system of claim 1, wherein the recommendation further provides a media type recommendation for the second item of media content.

12. The system of claim 1, wherein the data processor is further configured to automatically generate a license for a third party to generate the second item of media content.

13. The system of claim 1, wherein the interstitial content item is of a different media type than the first item of media content.

14. The system of claim 13, wherein the interstitial content item is a video game, and wherein the first item of media content is a movie.

15. The system of claim 1, wherein the first item of media content is a movie, a television program, or a video game.

16. The system of claim 1, wherein the interstitial content item is a video game, a movie, a television program, a video, a video short, user-generated content, a mashup, a book, or a comic book.

17. The system of claim 1, wherein the recommendation further provides a content recommendation for the second item of media content, wherein the content recommendation indicates a recommended subplot, storyline, character, or character arc.

18. The system of claim 1, wherein the one or more computer-readable mediums is further configured for storage of:
a second interstitial content data record, wherein the interstitial content data record identifies the first item of media content, a second interstitial content item, and an activity level associated with the second interstitial content item;
wherein the interstitial content item is associated with a first plot line, and wherein the second interstitial content item is associated with a second plot line;
wherein the recommendation further identifies the first plot line or the second plot line based on the activity level associated with the interstitial content item and the activity level associated with the second interstitial content item.

19. The system of claim 18, wherein the activity level associated with the interstitial content item indicates an average user interaction time with the interstitial content item;
wherein the activity level associated with the second interstitial content item indicates an average user interaction time with the second interstitial content item; and
wherein the content recommendation is based on a comparison of the average user interaction time with the interstitial content item and the average user interaction time with the second interstitial content item.

20. A method of continuing engagement of or growing an audience for a first item of media content and evaluating a recommendation for generation of a second item of media content after release of the first item of media content, comprising:
tracking an activity level associated with a first item of media content;
providing an interstitial content item associated with the first item of media content and tracking an activity level associated with the interstitial content item;
evaluating the activity level associated with the first item of media content and the activity level associated with the interstitial content item using a computer-implemented scoring model to generate a recommendation score;
generating a recommendation as to whether the second item of media content should be generated based on the recommendation score, wherein the recommendation is stored in a computer-readable medium.

21. A computer-readable medium encoded with instructions for commanding a processing system to execute steps for performing a method of continuing engagement of or growing an audience for a first item of media content and evaluating a recommendation for generation of a second item of media content after release of the first item of media content, the method comprising:
tracking an activity level associated with a first item of media content;
providing an interstitial content item associated with the first item of media content and tracking an activity level associated with the interstitial content item;
evaluating the activity level associated with the first item of media content and the activity level associated with the interstitial content item using a computer-implemented scoring model to generate a recommendation score;
generating a recommendation as to whether the second item of media content should be generated based on the recommendation score, wherein the recommendation is stored in a computer-readable medium.
